(19) United States
(12) Patent Application Publication
(10) Pub. No.: US 2025/0265777 A1
(43) Pub. Date: Aug. 21, 2025

(54) INFORMATION PROCESSING DEVICE AND RECORDING MEDIUM

(71) Applicant: SEGA CORPORATION, Tokyo (JP)

(72) Inventors: Sayuki Iwahashi, Tokyo (JP); Kohei Sasagawa, Tokyo (JP); Shoei Hayashi, Tokyo (JP)

(73) Assignee: SEGA CORPORATION, Tokyo (JP)

(21) Appl. No.: 19/201,467

(22) Filed: May 7, 2025

Related U.S. Application Data
(63) Continuation of application No. PCT/JP2023/036786, filed on Oct. 10, 2023.

(30) Foreign Application Priority Data
Nov. 9, 2022 (JP) 2022-179564

(51) Int. Cl. G06T 17/00

(52) U.S. Cl. CPC G06T 17/00

(57) ABSTRACT

An information processing device includes: a storage that stores replication assistance information in which each piece of production method instruction data is associated with a first user owning a finished product that is produced using components in a virtual space, the production method instruction data instructing a production method such that a second user can replicate the finished product; and a controller that gives the second user at least one component usable for producing the finished product in the virtual space, and in response to the at least one component being given to the second user, based on the replication assistance information, identifies production method instruction data for a finished product produced using the at least one component, as recommended production method instruction data, from among the production method instruction data of the finished product owned by the first user.

### BACKGROUND

### Technical Field

The present invention relates to an information processing device and a recording medium storing instructions.

### Description of Related Art

Conventional video games are configured to allow users to expand their communities by interacting with each other using their avatars (for example, avatars, characters, or the like) in a virtual space (for example, the Metaverse, a game field, or the like) (for example, Patent Document 1).

### Patent Document

Patent Document 1: JP 2002-56409 A

### Technological Problem to Be Solved by Invention

Such a virtual space contains a vast area in which avatars can act (for example, a vast area of land), and one user may own a portion of that vast area. By manipulating their avatars, users may obtain components that can be used to create finished products in the virtual space, and can create finished products made up of multiple components in their own owned area.

However, even if a user obtains new components, for example, by their avatar picking up components in the vast area or the like, the user may not know how to use these components to create a finished product.

### SUMMARY

One or more embodiments of the present invention efficiently provide a user, after acquiring a new part or component usable for producing a finished product, with an appropriate guide about how to use the part or component to produce the finished product.

According to one aspect of the present invention, an information processing device comprises:
a storage that stores replication assistance information in which each piece of production method instruction data is associated with a first user owning a finished product that is produced using components in a virtual space, wherein the production method instruction data instruct a production method such that a second user can replicate the finished product; and
a controller that:
gives the second user at least one component usable for producing the finished product in the virtual space, and
in response to the at least one component being given to the second user, based on the replication assistance information, identifies production method instruction data for a finished product produced using the at least one component, as recommended production method instruction data to be introduced to the second user, from among the production method instruction data of the finished product owned by the first user.

Other features of the present invention will become apparent from the specification of the present invention and the accompanying drawings.

### BRIEF DESCRIPTION OF DRAWINGS

FIG. 1 is a configuration diagram illustrating an example of an information processing system 1 according to one or more embodiments.

FIG. 2 is a hardware configuration diagram illustrating an example of a computer 50 according to one or more embodiments.

FIG. 3 is a functional block diagram illustrating an example of a server device 20 according to one or more embodiments.

FIG. 4 is a configuration diagram illustrating an example of part information according to one or more embodiments.

FIG. 5 is a configuration diagram illustrating an example of area information according to one or more embodiments.

FIG. 6 is a configuration diagram illustrating an example of owned area setting information according to one or more embodiments.

FIG. 7 is a configuration diagram illustrating one example of part acquisition area information according to one or more embodiments.

FIG. 8 is a configuration diagram illustrating an example of user information according to one or more embodiments.

FIG. 9 is a configuration diagram illustrating an example of replication assistance information according to one or more embodiments.

FIG. 10 is a functional block diagram illustrating an example of a client terminal 10 according to one or more embodiments.

FIG. 11 is a flowchart illustrating an example of an operation related to assembling a building in one or more embodiments.

FIG. 12 is a flowchart illustrating an example of an operation relating to generation of a blueprint in one or more embodiments.

FIG. 13 is a diagram illustrating a configuration example of a first screen on the client terminal 10.

FIG. 14 is a flowchart illustrating an example of an operation relating to the introduction and sale of a blueprint in one or more embodiments.

FIG. 15 is a diagram illustrating a configuration example of a second screen of the client terminal 10.

### DETAILED DESCRIPTION OF EMBODIMENTS

At least the following will become apparent from the description of the present specification and the accompanying drawings.

That is, an information processing device comprises:
a storage that stores replication assistance information in which each piece of production method instruction data is associated with a first user owning a finished product that is produced using components in a virtual space, wherein the production method instruction data instruct a production method such that a second user can replicate the finished product; and
a controller that:
gives the second user at least one component usable for producing the finished product in the virtual space; and
in response to the at least one component being given to the second user, based on the replication assistance information, identifies production method instruction data for a finished product produced using the at least one component, as recommended production method instruction data to be introduced to the second user, from among the production method instruction data of the finished product owned by the first user.

According to such an information processing device, when the second user acquires a new component, the production method instruction data is introduced that enables the second user to replicate a finished product made by the first user using that component, making it possible for the second user to understand how to use that component in making a finished product.

Furthermore, in this information processing device, the storage stores user information in which a component owned by the first user is set, from among components usable for producing the finished product in the virtual space, to be associated with the first user, and
in response to the at least one component being given to the second user, the controller identifies, based on the replication assistance information and the user information, production method instruction data for a finished product producible using the at least one component and the component owned by the first user, as the recommended production method instruction data to be introduced to the second user, from among the production method instruction data of the finished product owned by the first user.

According to such an information processing device, when the second user acquires a new component, the production method instruction data is introduced that enables the second user to replicate the finished product made by the first user using not only that component but also components owned by the first user, making it possible for the second user to efficiently understand how to use that component to produce the finished product.

Furthermore, in this information processing device, when identifying a plurality of pieces of the recommended production method instruction data, the controller preferentially identifies the recommended production method instruction data by which the finished product requiring a larger number of components is replicable.

According to such an information processing device, the recommended production method instruction data that makes it possible to replicate a finished product having a large number of components (for example, an attractive finished product having a complex structure) is preferentially introduced, thereby increasing the second user's motivation to produce an attractive finished product using the components obtained.

Furthermore, in this information processing device, a popularity ranking is set in the replication assistance information for respective pieces of the production method instruction data, and
when identifying a plurality of pieces of the recommended production method instruction data, the controller preferentially identifies the recommended production method instruction data of a higher popularity ranking.

According to such an information processing device, the recommended production method instruction data that makes it possible to replicate a popular and attractive finished product is preferentially introduced, thereby increasing the second user's motivation to produce an attractive finished product using the components obtained.

Furthermore, in this information processing device, the controller further sells the recommended production method instruction data to the second user, and gives a reward to the first user owning the finished product replicable using the recommended production method instruction data.

According to such an information processing device, because the production method instruction data is sold, the first user who owns the finished product replicable using the production method instruction data can receive a reward, thereby increasing the motivation to actively produce and own attractive finished products that many users will buy.

Furthermore, in this information processing device, the controller refrains from reselling the recommended production method instruction data that has been purchased and is already owned by the second user.

According to such an information processing device, excessive replication of a finished product can be suppressed by restricting the resale of the recommended production method instruction data once it has been purchased.

Furthermore, in this information processing device, the controller excludes production method instruction data that can replicate a finished product using a component that fulfills a certain condition from the recommended production method instruction data.

According to such an information processing device, when a component that meets a certain condition is used in production of the finished product replicable using the production method instruction data, it may be difficult to obtain this component, and there is a risk that the finished product cannot actually be replicated. By excluding such production method instruction data from the recommended production method instruction data, it is possible to prevent production method instruction data for a finished product that cannot actually be replicated using available components.

Furthermore, a non-transitory computer readable recording medium stores instructions causing a computer to execute:
storing replication assistance information in which each piece of production method instruction data is associated with a first user owning a finished product that is produced using components in a virtual space, wherein the production method instruction data instruct a production method such that a second user can replicate the finished product;
giving the second user at least one component usable for producing the finished product in the virtual space; and
in response to the at least one component being given to the second user, based on the replication assistance information, identifying production method instruction data for a finished product produced using the at least one component, as recommended production method instruction data to be introduced to the second user, from among the production method instruction data of the finished product owned by the first user.

According to the recording medium storing such instructions, it is possible to allow a user to understand how newly acquired components can be used to create a finished product.

### Embodiments

An information processing device, a recording medium storing instructions, an information processing method, and an information processing system according to one or more embodiments of the present invention will be described in detail below. Note that the present invention can be widely applied to a recording medium storing instructions, an information processing device, an information processing method, an information processing system, and the like that employ a virtual space provision service that provides a virtual space to a user. In one or more embodiments, an example will be described in which “parts,” as an example of components, are used to assemble (produce) a “building,” as an example of a finished product, in a virtual space.

### System Configuration

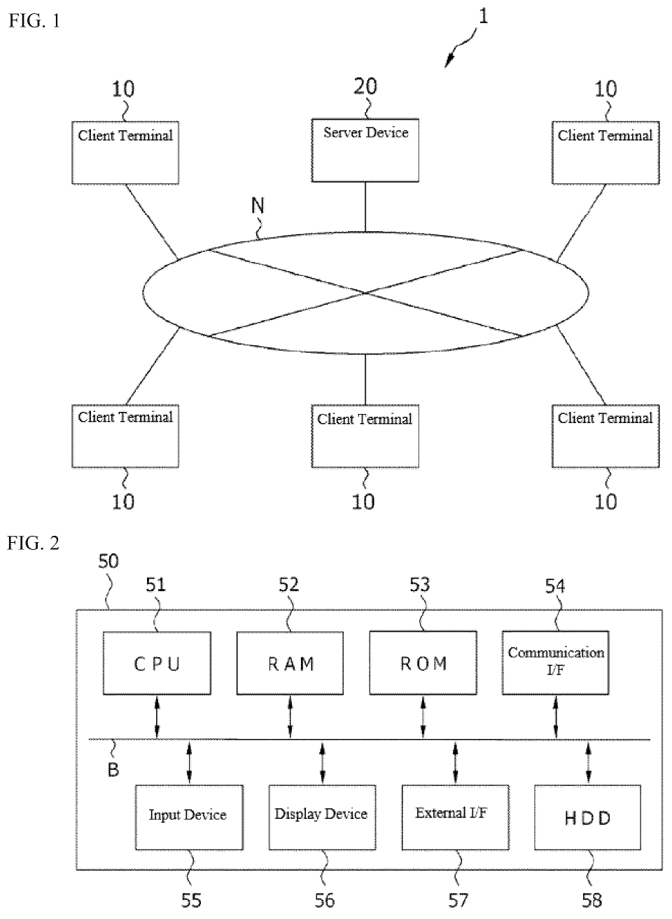

FIG. 1 is a configuration diagram illustrating an example of an information processing system 1 according to one or more embodiments. A s illustrated in FIG. 1, in the information processing system 1 according to one or more embodiments, one or more client terminals 10 and a server device 20 are connected via a network N.

The client terminal 10 is a terminal device such as a smartphone, tablet, or PC, or a terminal device such as a home or commercial game console operated by a user. The server device 20 manages and controls in the virtual space provision service performed by the user in the client terminal 10, performs billing processing in the virtual space provision service, and the like. The network N is the Internet or the like, and includes a mobile radio base station or the like.

Note that in addition to the client-server type information processing system 1 illustrated in FIG. 1, the present invention can also be applied to a stand-alone game device (information processing device) by providing a separate mechanism for performing billing processing within the virtual space. The information processing system 1 in FIG. 1 is merely one example, and it goes without saying that various other system configuration examples are possible depending on the application and purpose. For example, the server device 20 in FIG. 1 may be configured in a split manner across multiple computers.

### Hardware Configuration

### Client Terminal and Server Device

FIG. 2 is a hardware configuration diagram illustrating an example of a computer 50 according to one or more embodiments. The client terminal 10 and the server device 20 according to one or more embodiments are realized by, for example, a computer 50 having the hardware configuration illustrated in FIG. 2. Note that the computer 50 is an example of the information processing device.

As illustrated in FIG. 2, the computer 50 includes a central processing unit (CPU) 51, a random access memory (RAM) 52, a read only memory (ROM) 53, a communication interface 54, an input device 55, a display device 56, an external interface 57, and an HDD 58, all of which are interconnected via a bus line B. In addition, the server device 20 may be configured to connect and use the input device 55 and the display device 56 when necessary.

The CPU 51 is an arithmetic unit that reads out instructions such as a program and data from storage devices such as the ROM 53 and the HDD 58 onto the RAM 52 and executes various processes based on the read the instructions and data, thereby realizing control and functions of the entire computer.

The RAM 52 is an example of a volatile semiconductor memory (storage device) for temporarily storing the instructions and data, and is also used as a work area when the CPU 51 executes various processes.

The ROM 53 is an example of a non-volatile semiconductor memory (storage device) that can retain the instructions and data even when the power is turned off. The ROM 53 stores the instructions and data such as the BIOS executed when the computer 50 is started up, OS settings, and network settings.

The communication interface 54 is an interface for connecting the computer 50 to the network N. This allows the computer 50 to perform data communication via the communication interface 54.

The input device 55 is a device used by a user or an administrator to input various signals. The input device 55 in one or more embodiments is, for example, an operation device such as a touch panel, operation keys or buttons, a keyboard, or a mouse.

The display device 56 is a device for displaying various types of information on a screen to a user or an administrator. The display device 56 in one or more embodiments is, for example, a liquid crystal or organic EL display.

The external interface 57 is an interface for connecting to an external device so as to enable data communication. This allows the computer 50 to read and/or write from and to a recording medium via the external interface 57. The external device is, for example, a recording medium such as a floppy disk, a CD, a DVD, an SD memory card, or a USB memory.

The HDD 58 is an example of a non-volatile storage device that stores the instructions and data. The stored instructions and data include an OS, which is basic software that controls the entire computer, applications that provide various functions on the OS, and the like.

Note that instead of the HDD 58, a drive device using a flash memory as a storage medium (for example, a solid state drive: SSD) may be used.

The client terminal 10 and the server device 20 according to one or more embodiments can realize various processes, which will be described later, by executing the instructions on the computer 50 having the hardware configuration described above.

### Software Configuration

### Server Device

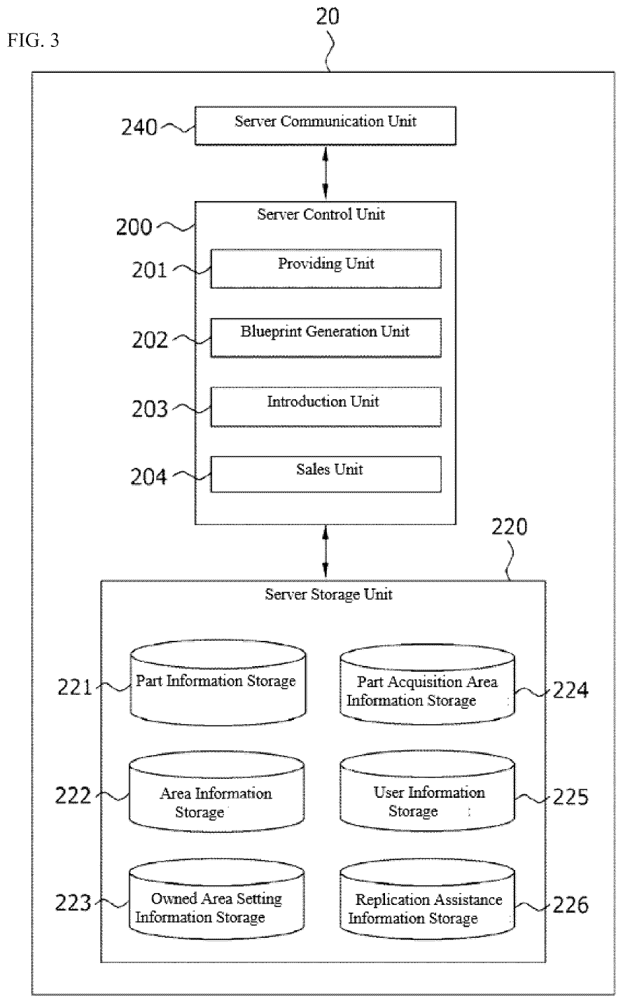

FIG. 3 is a functional block diagram illustrating an example of the server device 20 according to one or more embodiments. The server device 20 according to one or more embodiments is realized by, for example, the functional blocks illustrated in FIG. 3.

The server device 20 according to one or more embodiments realizes a server control unit (or server controller) 200 (e.g., CPU 51), a server storage unit (or server storage) 220 (e.g., HDD 58), and a server communication unit 240 (e.g., communication I/F 54) by executing the instructions.

The server control unit 200 has a function of executing various processes in the server device 20. The server control unit 200 in one or more embodiments includes a providing unit 201, a blueprint generation unit 202, an introduction unit 203, and a sales unit 204.

The providing unit 201 provides or gives to the user parts that can be used to produce a finished product in the virtual space. The providing unit 201 according to one or more embodiments assigns to the user any of a plurality of parts that can be used to assemble a building in a virtual space.

The blueprint generation unit 202 is an example of a production method instruction data generation unit, and generates blueprints for assembling a building in a virtual space. A blueprint is an example of “production method instruction data” that gives instructions for a production method so that another user can replicate a finished product owned by a user. The blueprint generation unit 202 according to one or more embodiments generates a blueprint that gives instructions for an assembly method so that other users can replicate a building based on the operation of the user who owns the building.

The introduction unit 203 introduces to the user a blueprint for replicating another person's building in the virtual space. When any of the parts that can be used to assemble a building in a virtual space is given to a user, the introduction unit 203 according to one or more embodiments determines, from among the blueprints of buildings owned by other users, a blueprint of a building in which that part is used as a recommended blueprint to be introduced to the user.

When a user wishes to purchase a recommended blueprint, the sales unit 204 performs billing processing based on the sales price of the recommended blueprint and the user's own money (for example, virtual currency) to sell the recommended blueprint. The sales unit 204 according to one or more embodiments, sells the recommended blueprint to a user to give a reward to other users who own buildings that can be replicated using the recommended blueprint.

The server storage unit 220 has a function of storing various types of information in the server device 20. The server storage unit 220 in one or more embodiments includes a part information storage 221, an area information storage 222, and an owned area setting information storage 223, a part acquisition area information storage 224, a user information storage 225, and a replication assistance information storage 226.

The part information storage 221 is an example of a part information storage unit, and stores part information relating to parts that can be used to assemble a building in a virtual space. The part information stored in the part information storage 221 is made up of various types of data described below.

FIG. 4 is a configuration diagram illustrating an example of part information according to one or more embodiments. The part information illustrated in FIG. 4 includes items such as a part ID, a part name, a category, and part setting information.

The part ID is information for uniquely identifying each part. The part name is information indicating the name of the part. The category is information indicating the classification to which the part belongs. In one or more embodiments, there are building material parts, indoor parts, outdoor parts, and the like. Building material parts include foundations, floors, roofs, walls, stairs, pillars, beams, windows, doors, and the like. Indoor parts include furniture such as chairs and tables. Outdoor parts include shrubs, planters, fountains, trees, and rocks. The part setting information is information including model data, texture data, and the like for forming a part as a 3D model (part object) in a virtual space (three-dimensional virtual space).

The area information storage 222 stores area information relating to areas in the virtual space. The area information stored by the area information storage 222 is configured by various types of data shown below.

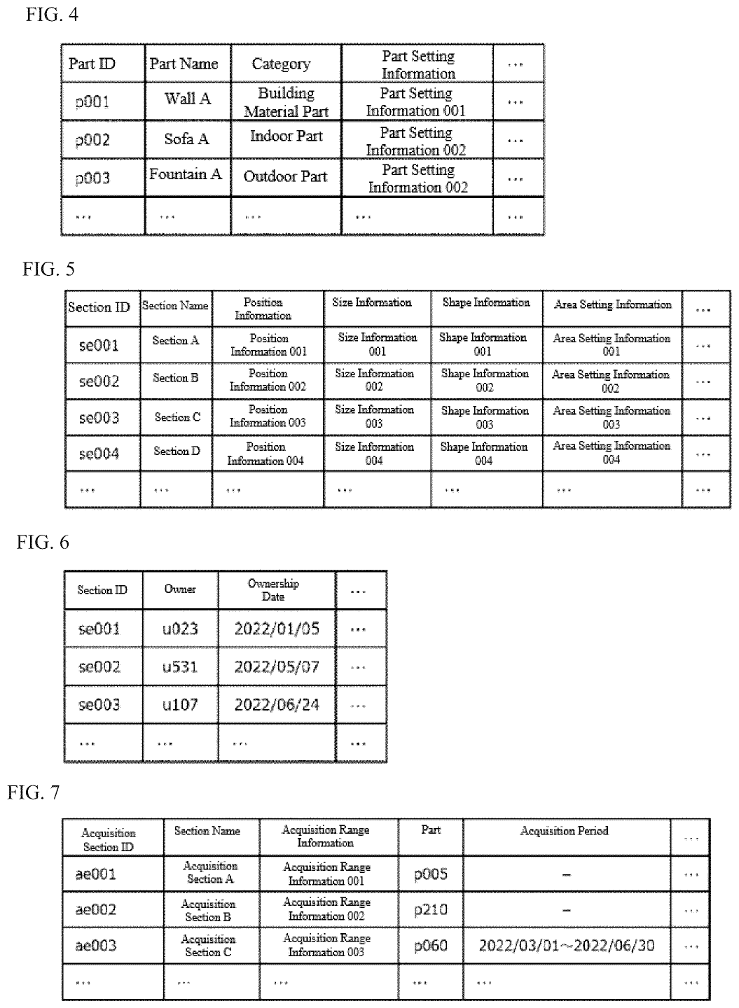

FIG. 5 is a configuration diagram illustrating an example of area information according to one or more embodiments. The area information illustrated in FIG. 5 includes items such as a section ID, a section name, position information, size information, shape information, and area setting information.

The section ID is information for uniquely identifying an area within the virtual space that is partitioned based on a predetermined criterion. The section name is information that indicates the name of an area in the virtual space. The position information is information for identifying the position of an area in the virtual space. The size information is information for identifying the size of an area in the virtual space. The shape information is information for identifying the shape of an area in the virtual space. The area setting information is information including model data, texture data, and the like for forming an area as a 3D model (land object) in a virtual space (three-dimensional virtual space).

The owned area setting information storage 223 stores owned area setting information relating to an area owned by a user (owned area) from among areas in the virtual space. The owned area setting information stored by the owned area setting information storage 223 is configured by various types of data shown below.

FIG. 6 is a configuration diagram illustrating an example of owned area setting information according to one or more embodiments. The owned area setting information illustrated in FIG. 6 includes items such as a section ID, an owner, and an ownership date.

The section ID is information for uniquely identifying an owned area in the virtual space that is assigned to the user as his/her own space. The owner is information that indicates the user who owns an area in the virtual space. The ownership date is information indicating the date when the user gained possession of the area in the virtual space.

The part acquisition area information storage 224 stores part acquisition area information relating to areas within the virtual space where the user can acquire parts. The part acquisition area information stored in the part acquisition area information storage 224 is made up of various types of data described below.

FIG. 7 is a configuration diagram illustrating one example of part acquisition area information according to one or more embodiments. The part acquisition area information illustrated in FIG. 7 includes items such as acquisition section ID, section name, acquisition range information, parts, and acquisition period.

The acquisition section ID is information for uniquely identifying an area within the virtual space where a part can be acquired. The section name is information that indicates the name of the part acquisition area. The acquisition range information is information for defining the range within the virtual space in which a part can be acquired. The acquired range information includes a section ID for identifying an area in the virtual space, position information defining a predetermined range within the area identified by the section ID, and the like. The parts are information indicating the parts that can be acquired within the range defined by the acquisition range information, from among the plurality of parts set in the parts information illustrated in FIG. 4. The acquisition period is information that defines a limited period during which the parts can be acquired.

The user information storage 225 stores user information related to a user who uses the virtual space provision service. The user information stored in the user information storage 225 is made up of various types of data shown below.

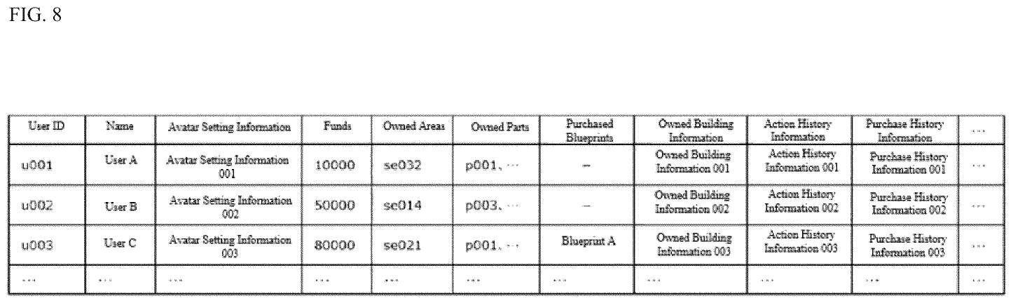

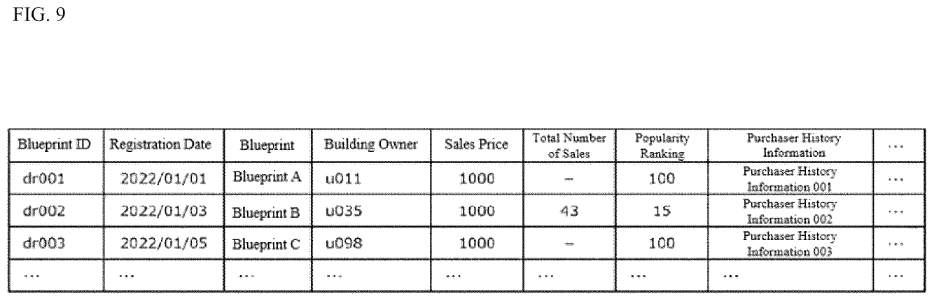

FIG. 8 is a configuration diagram illustrating an example of user information according to one or more embodiments. The user information illustrated in FIG. 8 includes items such as a user ID, a name, avatar setting information, funds, owned areas, owned parts, purchased blueprints, owned building information, action history information, and purchase history information.

The user ID is information for uniquely identifying a user. The name is information indicating the user's name. The avatar setting information is information relating to the avatar that the user uses in the virtual space. This includes model data, texture data, and the like for forming an avatar as a 3D model (user object) in a virtual space (three-dimensional virtual space). The funds is information relating to the virtual currency owned by the user. The owned area is information for identifying an area owned by the user among areas within the virtual space set in the area information illustrated in FIG. 5. The owned parts are information for identifying parts owned by the user from among the parts that can be used in the virtual space set in the parts information illustrated in FIG. 4. The purchased blueprints is information indicating the blueprints purchased by the user. The owned building information is information for identifying buildings owned by the user. The owned building information includes a building ID for uniquely identifying the user's owned buildings, the name of the building, the configuring parts (type and quantity of parts) that the user used to assemble the building from among the owned parts, layout information for identifying the layout of the position and orientation of the configuring parts of the building, information relating to the portions of the configuring parts that contact each other, the start date of assembly of the building, the completion date of assembly of the building, and the like. The action history information is information relating to the action history of an avatar in the virtual space. The purchase history information is information regarding the purchase history of the recommended blueprint.

The replication assistance information storage 226 stores replication assistance information for assisting the user to be able to replicate other people's buildings. The replication assistance information stored in the replication assistance information storage 226 is configured by various types of data shown below.

FIG. 9 is a configuration diagram illustrating an example of replication assistance information according to one or more embodiments. The replication assistance information illustrated in FIG. 9 includes items such as blueprint ID, registration date, blueprints, building owner, sales price, total number of sales, popularity ranking, and purchaser history information.

The blueprint ID is information for uniquely identifying a blueprint that can be used to assist in replicating a building. The registration date is information indicating the date and time when the blueprint was registered as a blueprint that can be used to assist in replicating a building. The blueprints will be available to assist in replicating the building from the registration date onward. The blueprint is generated by the blueprint generation unit 202, and is data for giving instructions for an assembly method so that other users can replicate a building owned by a user. The blueprint includes the configuring parts (type and quantity of parts) used to assemble a building that can be replicated using the blueprint, layout information for identifying the layout of the position and orientation of the configuring parts of the building, information relating to the portions of the configuring parts that contact each other, and the like. The building owner is information for identifying a user who owns a building that can be replicated using a blueprint. The sales price is information indicating the sales price set for the blueprint. The total number of sales is information indicating the number of blueprints that have been sold in the past. The popularity ranking is information that indicates a ranking determined based on the total number of sales as a popularity ranking. The higher the total number of sales, the higher the popularity ranking. The purchaser history information is history information relating to users who have purchased blueprints in the past.

The server communication unit 240 has a function of communicating with the client terminal 10 via the network N.

Note that as described above, in the information processing system 1 of one or more embodiments, the server device 20 performs control and the like related to part provision, blueprint generation, blueprint introduction, and blueprint sales, and the client terminal 10 may perform various controls and processing. Specifically, at least a portion of the providing unit, blueprint generation unit, introduction unit, and sales unit may be configured not to be provided in the server control unit 200 of the server device 20, but to be provided in the client control unit 100 of the client terminal 10.

### Client Terminal

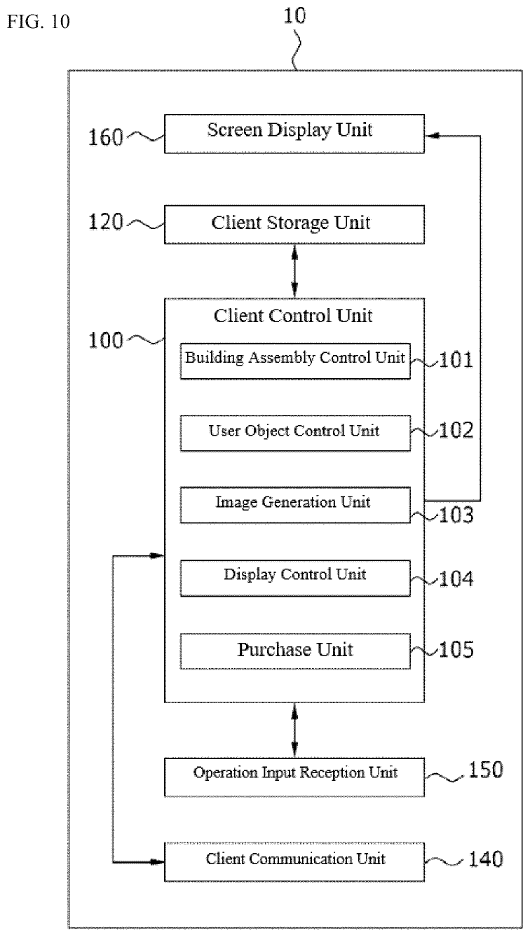

FIG. 10 is a functional block diagram illustrating an example of a client terminal 10 according to one or more embodiments. The client terminal 10 according to one or more embodiments is realized by, for example, the functional blocks illustrated in FIG. 10.

The client terminal 10 according to one or more embodiments realizes a client control unit (or client controller) 100 (e.g., CPU 51), a client storage unit (or client storage) 120 (e.g., HDD 58), a client communication unit 140 (e.g., communication I/F 54), an operation input receiving unit 150 (e.g., input device 55), and a screen display unit 160 (e.g., display device 56) by executing the instructions.

The client control unit 100 has a function of executing various processes in the client terminal 10. The client control unit 100 in one or more embodiments includes a building assembly control unit 101, a user object control unit 102, an image generation unit 103, a display control unit 104, and a purchase unit 105.

The building assembly control unit 101 is an example of a completed product generation unit, and performs control relating to the assembly of a building in the virtual space. The building assembly control unit 101 according to one or more embodiments successively arranges component objects, which are parts owned by the user, in the user's owned area based on user operations, generates a completed object, which is a building constructed by combining various component objects.

The user object control unit 102 performs control relating to user objects in the virtual space. The user object control unit 102 according to one or more embodiments controls various actions, such as moving and operating a user object, which is an avatar, in a virtual space, based on user operations.

The image generation unit 103 generates the state in the virtual space when viewing various objects arranged in the virtual space from a virtual camera as a two-dimensional image. The image generation unit 103 according to one or more embodiments performs coordinate conversion of various objects arranged in three-dimensional coordinates expressed in the world coordinate system into a view coordinate system based on the virtual camera. Then, perspective transformation and the like are performed on the objects arranged in the view coordinate system to generate the state of the virtual space (virtual three-dimensional space) when viewed from the virtual camera as a two-dimensional image. At this time, geometry processing, texture mapping processing, hidden surface processing, alpha blending processing, and the like are also performed.

The display control unit 104 controls the screen display of the client terminal 10. The display control unit 104 in one or more embodiments creates two-dimensional images of various objects arranged in the virtual space as viewed from a virtual camera frame by frame (for example, every 1/60 second) and outputs the state of the virtual space to the screen display unit 160.

The purchase unit 105 performs processing to allow the user to purchase blueprints for assembling a building in the virtual space. The purchase unit 105 according to one or more embodiments transmits a purchase request for a blueprint to the server device 20 in response to a user operation, and receives the purchased blueprint from the server device 20 according to the result of the billing process.

The operation input receiving unit 150 accepts operation inputs from a user. When a user performs a touch operation on the screen, the operation input receiving unit 150 according to one or more embodiments receives the operation input from the user via the touch panel.

The client storage unit 120 stores various instructions and various information required by the client terminal 10. The various instructions include a program that allows users to use the virtual space provision service. The various information includes, similar to the server storage unit 220, all or some of the part information, area information, owned area setting information, part acquisition area information, user information, and replication assistance information. That is, the client storage unit 120 also functions as a part information storage unit, an area information storage unit, an owned area setting information storage unit, a part acquisition area information storage unit, a user information storage unit, and a replication assistance information storage unit.

The client communication unit 140 communicates with the server device 20 via the network N.

The screen display unit 160 performs screen display on the client terminal 10 by receiving a control signal from the display control unit 104.

Note that, as described above, in the information processing system 1 according to one or more embodiments, the client terminal 10 performs building assembly control, user object control, image generation, display control, and the like, but the server device 20 may perform various controls and processing. Specifically, at least a portion of the building assembly control unit, the user object control unit, the image generation unit, and the display control unit may not be provided in the client control unit 100 of the client terminal 10, and may be provided in the server control unit 200 of the server device 20.

### System Overview

An overview of the information processing system 1 according to one or more embodiments will be described. In the information processing system 1 of one or more embodiments, a user can use the virtual space provision service.

In the virtual space provision service of one or more embodiments, a user can act within the virtual space using an avatar (user object) that represents the user. A plurality of areas in which avatars can act are set in this virtual space. An “area” in virtual space corresponds to “land” in real space.

A user can solely own one unowned parcel of an area by having it assigned to them as their own space from among the plurality of areas set in the virtual space. A user who has become an owner can freely use the area that they own.

Once a user becomes an owner, they can assemble a building such as a house using building material parts, indoor parts, outdoor parts, and the like within their owned area and control their avatar's actions within the building. Furthermore, if another person's avatar visits a building that the user has constructed, the user can communicate with them using their own avatar.

Incidentally, when assembling a building within one's own area, a user must collect various parts in the virtual world that can be used to assemble buildings. A plurality of part acquisition areas are set in the virtual space, so the user moves their avatar to one of the part acquisition areas in order to acquire parts. If the avatar searches within the part acquisition area, finds a part and picks it up, the user can obtain that part.

On the other hand, even if the user is able to obtain a certain part, there are cases where the user does not know how to use it to assemble a building. Therefore, in one or more embodiments, when a user obtains a part, a blueprint of a building that another user has assembled using that part is introduced to the user. By looking at the blueprint, the user can get reference for how the part is used in another person's building that can be replicated using that blueprint, and can understand how to use that part to assemble the building.

In addition, in one or more embodiments, if the user likes the introduced blueprint, the user can purchase the blueprint. If a user who has made a purchase can collect and assemble various parts according to the blueprint, they can obtain a building identical to the original building illustrated in the blueprint.

### System Operation

The operation of the information processing system 1 according to one or more embodiments will be described. Below, the operations relating to assembling a building in the virtual space, the operations relating to generating blueprints, and the operations relating to introducing and selling the blueprints will be described in detail.

### Building Assembly

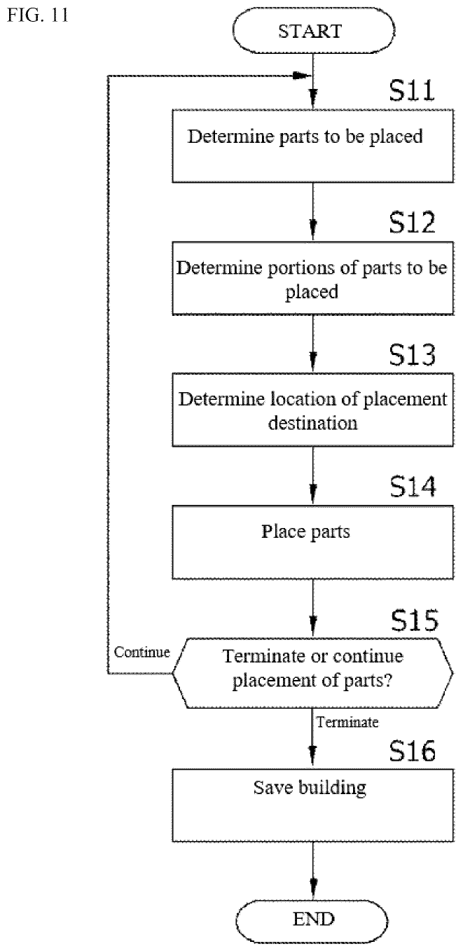

The operations for assembling a building in the virtual space in one or more embodiments will be described with reference to FIG. 11. FIG. 11 is a flowchart illustrating an example of an operation relating to assembling a building in one or more embodiments.

The building assembly control unit 101 of the client terminal 10 determines parts (hereinafter referred to as “parts to be placed”) to be placed in a user's owned area from among the parts owned by the user based on a designation operation by the user (step S11).

Next, the building assembly control unit 101 of the client terminal 10 determines, based on the user's designation operation, the portions that are adjacent to the placement location described below from among the various portions of the determined parts to be placed (step S12).

Note that it is also possible to set in advance the portions that are adjacent to the placement location without having the user specify the portions of the parts to be placed in this manner. In this case, the process of step S12 can be omitted.

Next, the building assembly control unit 101 of the client terminal 10 determines the location of the placement destination based on the user's designation operation (step S13).

For example, if the placement location is any point within the owned area, the point within the owned area designated by the user's operation is determined to be the placement destination. Also, when the placement location is a component part of a building that has already been placed, the portion of the component part designated by the user's operation is determined as the placement destination.

Note that when the placement location is a component part of a building that has already been placed, it is possible to allow the user to specify the component part as the placement destination regardless of the portion by setting the portion of the component part adjacent to the part to be placed without making the user specify the portion of the component part as the placement destination.

Next, the building assembly control unit 101 of the client terminal 10 places the determined parts to be placed at the determined placement location within the user's owned area (step S14).

By specifically laying out the parts within the owned area in this manner, the parts to be placed become component parts of the building.

Note that when placing such parts, the user object control unit 102 of the client terminal 10 may make the user's avatar perform the action of carrying the determined part to be placed to the determined placement location.

Next, the building assembly control unit 101 of the client terminal 10 determines whether a termination operation for terminating part placement, or a continue operation for continuing part placement, has been performed by the user (step S15).

Then, when the building assembly control unit 101 of the client terminal 10 determines that the user has performed the continue operation (step S15: continue), the process returns to step S11 described above and assembly of the building is continued by having the user specify the next part to be placed. On the other hand, when it is determined that the user has performed the termination operation (step S15: terminate), the process proceeds to the next step S16.

Next, when the user has performed the end operation, the building assembly control unit 101 of the client terminal 10 stores the building assembled using the currently placed component parts in the user's owned building information as an owned building owned by the user (step S16).

### Making of Blueprints

In the information processing system 1 according to one or more embodiments, a blueprint can be generated based on a building assembled by a user (making of blueprint). By choosing to create a blueprint, the user can show other users the blueprints of their own building and demonstrate how it is assembled. Furthermore, the user can keep the original building they created and transfer the blueprint of that building to another user. Other users who have received the blueprint can then collect and assemble various parts according to the blueprint to replicate the original building.

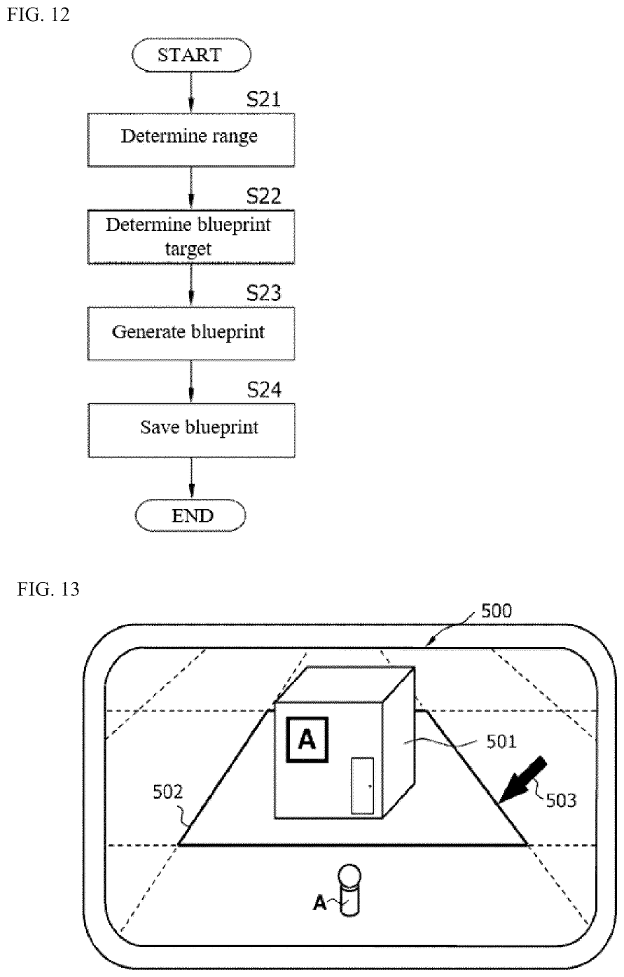

Hereinafter, the operations relating to the generation of blueprints in one or more embodiments will be described with reference to FIG. 12 and FIG. 13. FIG. 12 is a flowchart illustrating an example of an operation relating to generation of a blueprint in one or more embodiments. FIG. 13 is a diagram illustrating a configuration example of a first screen of the client terminal 10.

The client control unit 100 determines a range based on an operation by the user who wishes to create a blueprint (step S21).

On the first screen 500 illustrated in FIG. 13, an avatar A of the user, an owned building 501 of the user, a frame 502, and a cursor 503 are displayed. When the user touches the first screen 500 with their finger and moves the cursor 503, the user can change the size of the frame 502. When the user wishes to create a blueprint of the owned building 501, the user moves the cursor 503 so as to surround the owned building 501 with the frame 502, and then releases their finger from the first screen 500. The blueprint generation unit 202 determines the range at the timing when the user releases their finger from the first screen 500.

Next, the client control unit 100 determines, as a blueprint target, an owned building that has been assembled using various owned parts that exist within the range determined in this manner (step S22).

Here, when the user performs an operation to permit the creation of a blueprint of the owned building that is the determined blueprint target, the client control unit 100 transmits the owned building information of the user to the server device 20, and sends a request to execute the blueprint creation process.

Next, upon receiving the request for the blueprint creation process, the blueprint generation unit 202 of the server device 20 generates a blueprint to instruct other users on how to assemble the owned building so that the owned building can be replicated based on the owned building that is the determined blueprint target (step S23).

At this time, the blueprint generation unit 202 of the server device 20 generates a blueprint based on the received owned building information of the user, by determining the type and quantity of component parts used in assembling the owned building that is the determined target for blueprinting, the position and orientation in which each of the component parts of the owned building is laid out, and the like.

Next, the blueprint generation unit 202 of the server device 20 generates a blueprint corresponding to the owned building that is the determined blueprint target, then stores the generated blueprint in the replication assistance information in association with the user (step S24).

### Blueprint Introduction and Sales

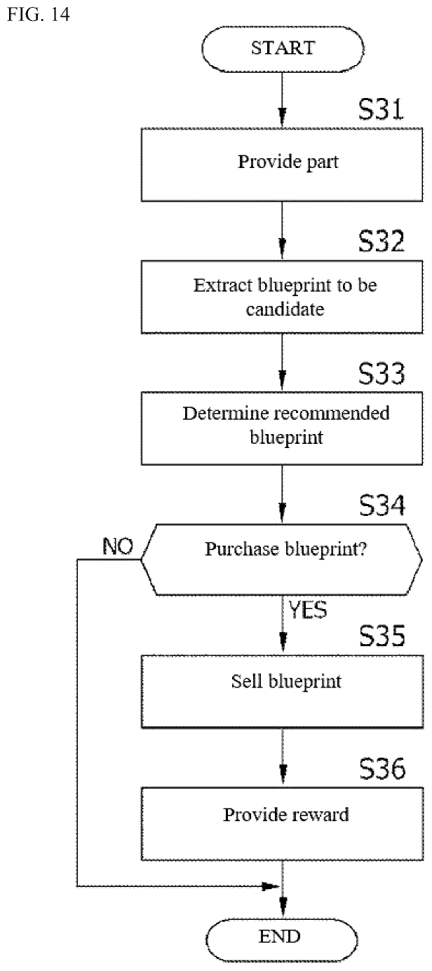

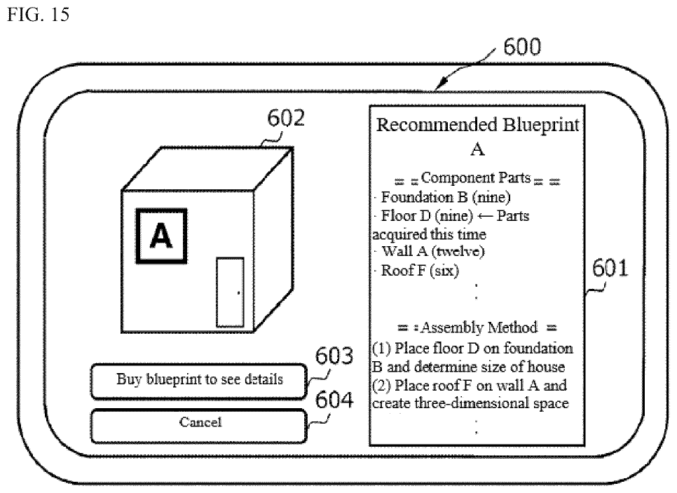

The operations relating to the introduction and selling of blueprints in one or more embodiments will be described with reference to FIG. 14 and FIG. 15. FIG. 14 is a flowchart illustrating an example of an operation relating to the introduction and sale of a blueprint in one or more embodiments. FIG. 15 is a diagram illustrating a configuration example of a second screen of the client terminal 10.

The providing unit 201 of the server device 20 provides or gives to the user, on the condition that the user's avatar has searched the part acquisition area based on the part acquisition area information, and found and picked up a part, the part associated with the part acquisition area (that is, the part that has been picked up) (step S31).

Next, when the parts are given to the user in this manner, the introduction unit 203 of the server device 20 extracts, from among the plurality of blueprints set in the replication assistance information, the blueprints of the building in which the provided (or given) parts are used (step S32).

At this time, the introduction unit 203 of the server device 20 excludes the blueprints associated with the user to which the part has been given. In other words, only the blueprints of other people's buildings are extracted, not including the blueprints of one's own buildings. Furthermore, when the same blueprint is associated with two or more different users, only the blueprint associated with the user of the earliest registration date is extracted. In other words, only the blueprints of the original building are extracted, not including the blueprints of the replicated buildings. Additionally, building blueprints that use parts that meet certain conditions (for example, parts whose acquisition period has expired) will be excluded. In other words, only the blueprints of buildings that can be replicated using available component parts are extracted, not including blueprints of buildings that cannot be replicated because the component parts are substantially difficult to obtain.

Note that the introduction unit 203 of the server device 20 may also refer to the user information of the user to extract, from among the plurality of blueprints set in the replication assistance information, a blueprint of a building that can be assembled using the provided parts and the owned parts of the user.

Next, the introduction unit 203 of the server device 20 determines a recommended blueprint to be introduced to the user from among the extracted plurality of blueprints (step S33).

At this time, the introduction unit 203 of the server device 20 can determine a blueprint of a building that can be assembled using the provided parts and the user's owned parts as a recommended blueprint by referring to the plurality of extracted blueprints. Furthermore, the introduction unit 203 can prioritize the blueprint that has the greatest number of building parts that can be replicated from the plurality of extracted blueprints and determine it as a recommended blueprint. Furthermore, a blueprint having a high popularity ranking can be prioritized as a recommended blueprint. Furthermore, a randomly selected blueprint may also be determined as a recommended blueprint. Note that the determination may be made using any one of these methods, or by a suitable combination of these methods. Furthermore, a plurality of recommended design plans may be determined.

The second screen 600 illustrated in FIG. 15 displays a recommended blueprint 601 introduced to the user, a building 602 that can be replicated using the recommended blueprint, a purchase button 603, and a termination button 604. By looking at the recommended blueprint 601 on the second screen 600, the user can understand how the parts acquired this time are used to assemble the building 602. Moreover, if the user likes the building 602 that can be replicated using a recommended blueprint, they can purchase the recommended blueprint 601 by pressing the purchase button 603. When the user presses the purchase button 603, the purchase unit 105 of the client terminal 10 transmits a purchase request for the recommended blueprint 601 to the server device 20. Furthermore, when the user presses the termination button 604, a request to end the introduction of the recommended blueprint 601 is transmitted to the server device 20.

Next, the introduction unit 203 of the server device 20 determines whether the user will purchase the recommended blueprint based on whether a purchase request for the recommended blueprint 601 has been received (step S34).

When a request to terminate the introduction of the recommended blueprint 601 is received, the introduction unit 203 of the server device 20 determines that the user will not purchase the recommended blueprint (step S34: NO), and terminates the processing of the flowchart illustrated in FIG. 14. In contrast to this, when a purchase request for the recommended blueprint 601 is received, it is determined that the user will purchase the recommended blueprint (step S34: YES), and the process proceeds to the next step S35.

Next, when it is determined that a recommended blueprint 601 is to be purchased, the sales unit 204 of the server device 20 refers to the user information and replication assistance information of the user, and sells the recommended blueprint 601 by performing a billing process based on the user's funds and the sales price of the recommended blueprint 601 (step S35).

Next, when the sales unit 204 of the server device 20 sells the recommended blueprint 601 to the user, it provides a reward to another user who owns the building 602 that can be replicated using the recommended blueprint 601 (step S36).

At this time, the sales unit 204 of the server device 20 can use all or part of the sales price of the recommended blueprint 601 as a reward to the other user. Note that, alternatively, a preset reward (a fixed amount of virtual currency, a specified part, a specified blueprint, a specified outfit for an avatar, or the like) may be given.

As described above, according to the information processing system 1 of one or more embodiments, when a user obtains a part, a recommended blueprint is introduced to the user that makes it possible to replicate a building assembled by another user using that part. By looking at the recommended blueprint, the user can get reference for how the part is used in another person's building, and can understand how to use that part to assemble the building. Furthermore, if the user likes the introduced recommended blueprint, they can purchase the recommended blueprint. If the user can collect and assemble various parts according to the purchased recommended blueprint, they can assemble a building identical to the original building illustrated in the recommended blueprint.

### Other Embodiments

The above embodiments are provided to facilitate understanding of the present invention, and should not be interpreted as limiting the present invention. The present invention can be modified or improved without departing from the spirit thereof, and the present invention also includes equivalents thereof. In particular, the embodiments described below are also included in the present invention. In other words, the present invention can be configured by appropriately combining the above embodiments with the embodiments described below.

Furthermore, it is also possible to construct various inventions by appropriately combining multiple invention-defining matters disclosed in the above embodiments. For example, an invention may be constructed by removing some of the invention-defining matters from all of the invention-defining matters disclosed in the above embodiments, or an invention may be constructed by appropriately combining all of the invention-defining matters disclosed in the above embodiments with the invention-defining matters disclosed in the embodiments described below.

### Sales of Blueprints

In the embodiments described above, the sales unit 204 of the server device 20 can also set so that a recommended blueprint that the user has purchased and already owns (purchased blueprint) cannot be resold.

In addition, in the embodiments described above, the sales unit 204 of the server device 20 may restrict blueprints of buildings that have fewer than a predetermined number of parts or that take less than a predetermined total time to complete from being sold as recommended blueprints. In other words, blueprints for buildings that are easy to assemble are of low value and can be excluded from sale.

Moreover, in the embodiments described above, if a user replicates a building identical to an original building according to a recommended blueprint (purchased blueprint) that they have purchased and already own, and then adds a new part to assemble a building different from the original building, it may be possible to create a blueprint for only that customized expanded portion, and the blueprint for that expanded portion may be added to the items for sale. In this case, the original building blueprint and the blueprint for the expanded portion may be sold as a set. When selling as a set, the reward to the owner may be set to be shared between the owner of the original building and the owner of the expanded portion.

### Making of Blueprints

In the above embodiments, when the range of the frame 502 is determined by the movement of the cursor 503 (the process of step S21 illustrated in FIG. 12), the blueprint generation unit 202 can determine that only the building material parts (for example, foundations, floors, roofs, walls, stairs, pillars, beams, windows, doors, or the like), outdoor parts (for example, shrubs, planters, fountains, trees, rocks, or the like), indoor parts (for example, furniture such as chairs and tables, or the like), and other parts that make up the owned building 501 within the determined range are to be made into the blueprint. This allows blueprints to be made of essentially just the building.

### Finished Product

Furthermore, in the embodiments, an example was described wherein the completed product in the virtual space is a “building”, but the present invention is not limited to this. For example, vehicles such as cars, motorcycles, bicycles, airplanes, ships, and the like in the virtual space, electrical appliances in the virtual space, toys in the virtual space, food in the virtual space, and the like can be made to be the finished product.

### Production Method Instruction Data

Furthermore, in the above embodiments, an example of production method instruction data was described, but the present invention is not limited to this. For example, assembly manuals, instruction manuals, recipes, and the like may be used as production method instruction data.

Although the disclosure has been described with respect to only a limited number of embodiments, those skilled in the art, having benefit of this disclosure, will appreciate that various other embodiments may be devised without departing from the scope of the present invention. Accordingly, the scope of the invention should be limited only by the attached claims.

### Description of Reference Numerals

1 Information processing system, 10 Client terminal, 10A Client terminal, 10B Client terminal, 20 Server device, 50 Computer, 51 CPU, 52 RAM, 53 ROM, 54 Communication interface, 55 Input device, 56 Display device, 57 External interface, 58 HDD, 100 Client control unit, 101 Building assembly control unit, 102 User object control unit, 103 Image generation unit, 104 Display control unit, 105 Purchase unit, 120 Client storage unit, 140 Client communication unit, 150 Operation input receiving unit, 160 Screen display unit, 200 Server control unit, 201 Providing unit, 202 Blueprint generation unit, 203 Introduction unit, 204 Sales unit, 220 Server storage unit, 221 Part information storage unit, 222 Area information storage unit, 223 Owned area setting information storage unit, 224 Part acquisition area information storage unit, 225 User information storage unit, 226 Replication assistance information storage unit, 240 Server communication unit, 500 First screen, 501 Owned building, 502 Enclosure, 503 Cursor, 600 Second screen, 601 Recommended blueprint, 602 Building, 603 Purchase button, 604 Cancel button, B Bus line, N Network

What is claimed is:

1. An information processing device, comprising:
a storage that stores replication assistance information in which each piece of production method instruction data is associated with a first user owning a finished product that is produced using components in a virtual space, wherein
the production method instruction data instruct a production method such that a second user can replicate the finished product; and
a controller that:
gives the second user at least one component usable for producing the finished product in the virtual space, and
in response to the at least one component being given to the second user, based on the replication assistance information, identifies production method instruction data for a finished product produced using the at least one component, as recommended production method instruction data to be introduced to the second user, from among the production method instruction data of the finished product owned by the first user.

2. The information processing device according to claim 1, wherein
the storage further stores user information in which a component owned by the first user is set, from among components usable for producing the finished product in the virtual space, to be associated with the first user, and
in response to the at least one component being given to the second user, the controller identifies, based on the replication assistance information and the user information, production method instruction data for a finished product producible using the at least one component and the component owned by the first user, as the recommended production method instruction data to be introduced to the second user, from among the production method instruction data of the finished product owned by the first user.

3. The information processing device according to claim 1, wherein
when identifying a plurality of pieces of the recommended production method instruction data, the controller preferentially identifies the recommended production method instruction data by which the finished product requiring a larger number of components is replicable.

4. The information processing device according to claim 1, wherein
a popularity ranking is set in the replication assistance information for respective pieces of the production method instruction data, and
when identifying a plurality of pieces of the recommended production method instruction data, the controller preferentially identifies the recommended production method instruction data of a higher popularity ranking.

5. The information processing device according to claim 1, wherein
the controller further:
sells the recommended production method instruction data to the second user, and gives a reward to the first user owning the finished product replicable using the recommended production method instruction data.

6. The information processing device according to claim 5, wherein
the controller refrains from reselling the recommended production method instruction data that has been purchased and is already owned by the second user.

7. The information processing device according to claim 1, wherein
the controller excludes production method instruction data that can replicate a finished product using a component that fulfills a certain condition from the recommended production method instruction data.

8. A non-transitory computer readable recording medium storing instructions causing a computer to execute:
storing replication assistance information in which each piece of production method instruction data is associated with a first user owning a finished product that is produced using components in a virtual space, wherein the production method instruction data instruct a production method such that a second user can replicate the finished product;
giving the second user at least one component usable for producing the finished product in the virtual space; and
in response to the at least one component being given to the second user, based on the replication assistance information, identifying production method instruction data for a finished product produced using the at least one component, as recommended production method instruction data to be introduced to the second user, from among the production method instruction data of the finished product owned by the first user.
